(19) United States
(12) Patent Application Publication
(10) Pub. No.: US 2008/0017742 A1
(43) Pub. Date: Jan. 24, 2008

(54) Belt Retractor Having A Switchable Force Limiter

(76) Inventors: Frederik Wigstrom, Goteborg (SE); Nicolaas Jansen, Alingsas (SE); Per Derevall, Alingsas (SE)

Correspondence Address: BRINKS HOFER GILSON & LIONE, P.O. BOX 10395, CHICAGO, IL, 60610, US

(21) Appl. No.: 11/547,873

(22) PCT Filed: Mar. 18, 2005
(86) PCT No.: PCT/EP05/02910

§ 371 Date: Jun. 11, 2007

(30) Foreign Application Priority Data
Apr. 10, 2004 (DE) 10 2004 017 725.2

(51) Int. Cl. B60R 22/34

(52) U.S. Cl. 242/379.1

(57) ABSTRACT

A motor vehicle seat belt retractor is provided with a force limiting device with at least two stages and with a switching device switchable by means of a pyrotechnic drive for setting a different force level for the force limiting device. A shaft ring is provided as a switching device which controls coupling elements serving to determine the force level, which can be displaced axially in the direction of the shaft axis between a holding position for the coupling elements and a release position of the pyrotechnic drive. The pyrotechnic drive for the shaft ring is in the form of an annular piston which is located in a housing bordering the shaft ring on an end thereof, which can be displaced in the axial direction and which lies against the shaft ring, which in case of activation is urged by the gas generated by a pyrotechnic charge and introduced into the housing and displaced in the axial direction.

### CROSS REFERENCE TO RELATED APPLICATIONS

This application claims priority to German Patent Application No. 10 2004 017 725.2, filed Apr. 10, 2004 and PCT/EP2005/002910, filed Mar. 18, 2005.

### BACKGROUND AND SUMMARY OF THE INVENTION

The invention relates to a motor vehicle seat belt retractor having a switchable force limiter with a force limiting device with at least two stages, and with a switching device for setting a different seat belt tension force level for the force limiter by means of a pyrotechnic drive. In the retractor of this invention, a shaft ring is provided as a switching device which controls coupling elements serving to determine the force level and which can be displaced axially in the direction of the shaft axis between a holding position for the coupling elements and a release position of the pyrotechnic drive.

A belt roller with the aforementioned general characteristics is described in DE 199 27 427 C2 and its corresponding U.S. Pat. No. 6,616,081, which are both hereby incorporated by reference. In accordance with the previously referenced patents, the belt roller is provided with a torsion rod formed in two stages as a force limiter for setting the seat belt tension force level, whereby the switching device in the belt roller ensures that, for example, considering the interaction of the belt roller with an airbag, switchover is effected from the higher force level to a lower force level at a certain time. In order also to make switchover possible under retractor loading conditions, the switching device of the referenced patents includes a coupling latch which is positioned so as to tend to open of its own accord, which is held fast in its coupling position by an axially displaceable shaft ring; if the shaft ring is displaced through the effect of a pyrotechnic actuator, the coupling latch takes up its release position, without the need to apply further actuation forces for the switching process.

The drive for the displacement of the shaft ring is in the form of an actuating ring which can be rotated by radial introduction of gas. The rotary movement is translated via tilted ramps situated between the actuating ring and a housing into axial displacement of the actuating ring. This axial displacement of the actuating ring is transferred to the shaft ring by means of the mutual contact of actuating ring and shaft ring.

The known form of the drive for the shaft ring described above involves the disadvantage, that its construction and operation of actuating the ring and the ramps, as well as the associated housing form, is complicated as regards manufacture and assembly. The present invention is based on the task of simplifying the drive for the axial movement of the shaft ring in a belt roller in a retractor with the generic characteristics described by the above-referenced and incorporated patents.

The basic principle of the present invention is that the drive for the shaft ring is in the form of an annular piston which is axially displaceable within a housing which borders the shaft ring on the front side and which lies against the shaft ring, which in case of activation is forced by gas generated by a pyrotechnic charge introduced into the housing and displaced in the axial direction. The advantage associated with the invention that no particular mechanism has to be present for the movement of the annular piston influencing the shaft ring, as the gas released by the pyrotechnic drive charge can be introduced into the housing in any desired direction and directly urges the axial displacement of the annular piston by means of expansion; as annular piston and shaft ring have the same direction of displacement, it is not necessary to convert the movement of the ring from rotation to translation.

According to one embodiment of the present invention it is provided that the shaft ring, which is itself in the form of an annular piston, is located in the housing which overlaps it and can be influenced by the gas which is introduced into the housing; this form incorporates the particular advantage that the number of components which are necessary is reduced, as only the annular piston formed as a shaft ring has to be accommodated in the associated housing.

It can be provided for that the annular piston is sealed against the housing wall which overlaps it.

In order to ease the stress placed on the mechanical portions of the invention by the gas pressure which influences them, one embodiment of the invention provides that the annular piston releases an opening at the end of the axial displacement travel so that the gas which is introduced into the housing can flow out.

According to one embodiment of the invention it is provided that a stop is provided on the belt shaft for the shaft ring as a limit of its travel path.

### BRIEF DESCRIPTION OF THE DRAWINGS

In the drawing, an embodiment of the invention is shown which is described below.

FIG. 1 shows the end of a belt shaft with shaft ring arranged as to be displaceable on the belt shaft and the associated drive for this in two schematic views, whereby the initial state before displacement of the shaft ring is shown beneath the longitudinal axis of the shaft, and the switching state after displacement of the shaft ring is shown above the longitudinal axis of the shaft.

### DETAILED DESCRIPTION OF THE INVENTION

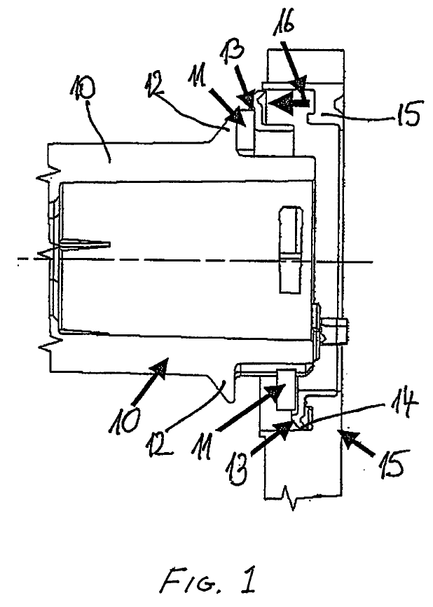

Referring to FIG. 1, on the end area of a belt shaft 10 on to which seat belt webbing (not shown) is wrapped, a shaft ring 11 can be axially displaced in the left-hand direction as the elements are shown in FIG. 1 up to a limit at a radial stop 12 formed on the belt shaft 10. The task and function of the shaft ring 11 in connection with the force limiter formed on the belt roller, and its switching, are described in detail in generic patent DE 199 27 427 C2 and corresponding U.S. Pat. No. 6,616,081, so that reference is made to those disclosures in this document and the description contained therein are also made the object of the present patent application.

Next to shaft ring 11 and lying against it axially in the initial position, an annular piston 13 is arranged in a housing 15, which is sealed against the inner wall of housing 15 by means of a circumferential seal 14.

If the gas from a pyrotechnic drive charge, not shown, is released into housing 15 in a volume defined in part by seal 14, the expansion of the gas in housing 15 leads to annular piston 13 being displaced axially in the direction of arrow 16 from its holding position, in the process pushing itself onto the end of belt shaft 10, for which purpose the annular piston 13 is in the form of a circular ring. During its axial displacement, annular piston 13 drives shaft ring 11 lying against it and displaces shaft ring 11 up to its limit against stop 12; in this switching position shaft ring 11 releases the coupling latches between the belt shaft 10 and a torque tube, which implements switching to a lower force limiting level as detained in the patents incorporated by reference herein. This switched position is referred to as the release position. Once in the release position, the housing 15, the piston 13, or the seal 14 may have provisions to vent the gas from the pyrotechnic drive charge.

As is not further shown, shaft ring 11 can itself be formed as an annular piston and be located in housing 15, for which purpose shaft ring 11 then is provided with a seal 14 running around the outside, so that the gas introduced into housing 15 directly affects shaft ring 11 without a separate piston element.

The characteristics of the object revealed in the above description, the patent claims, the summary and the drawing contained in these documents can be of importance both separately and in any combination or combinations with one another for realisation of the invention in its different embodiments.

While the above description constitutes the preferred embodiment of the present invention, it will be appreciated that the invention is susceptible to modification, variation and change without departing from the proper scope and fair meaning of the accompanying claims.

1. A seat belt retractor comprising a force limiting device with at least two stages, a switching device switchable by means of a pyrotechnic drive for setting a different force level for the force limiting device, a shaft ring acting as a switching device which controls coupling elements serving to determine the force level, the shaft ring displacable axially in the direction of the shaft axis between a holding position for the coupling elements and a release position of the pyrotechnic drive, an annular piston which is located in a housing adjacent to the shaft ring, which can be displaced axially and which lies against the shaft ring, the annular piston is influenced by the gas generated by a pyrotechnic charge and introduced into the housing acts on the piston to exert on axial force on the piston to displace the piston in the axial direction.

2. A seat belt retractor according to claim 1, further comprising the shaft ring, further forms the annular piston and is located in housing which overlaps it and can be influenced by the gas introduced into the housing.

3. A seat belt retractor according to claim 1, further comprising that the annular piston is sealed against a housing wall which encloses the piston.

4. A seat belt retractor according to claim 1, further comprising that the annular piston releases an opening at the end of an axial displacement path of the piston so that the gas introduced into housing can stream out.

5. A seat belt retractor according to claim 1, further comprising that a stop for the shaft ring is formed on the belt roller as a limit for its displacement path.
